(19) United States
(12) Patent Application Publication
(10) Pub. No.: US 2023/0039799 A1
(43) Pub. Date: Feb. 9, 2023

(54) WIRE HARNESS AND METHOD FOR MANUFACTURING WIRE HARNESS

(71) Applicant: SUMITOMO WIRING SYSTEMS, LTD., Yokkaichi-shi (JP)

(72) Inventors: Yusuke KITO, Yokkaichi-shi (JP); Katsuhiro IWAMOTO, Yokkaichi-shi (JP)

(73) Assignee: SUMITOMO WIRING SYSTEMS, LTD., Yokkaichi-shi (JP)

(21) Appl. No.: 17/879,365

(22) Filed: Aug. 2, 2022

(30) Foreign Application Priority Data
Aug. 5, 2021 (JP) 2021-129147

(51) Int. Cl. H01R 13/6591; H01R 13/6593; B60R 16/02; H01B 7/00; H01B 13/012

(52) U.S. Cl. CPC H01R 13/65912; H01R 13/6593; B60R 16/0215; H01B 7/0045; H01B 13/01263; H01R 2201/26

(57) ABSTRACT

A wire harness including: a first wire that is electrically connectable to a first connector installed in a vehicle; a second wire that is electrically connected to the first wire; a third wire that is electrically connected to the first wire; a connection where the first wire, the second wire, and the third wire are electrically connected to each other; a tubular first shield that surrounds an outer periphery of the connection and an outer periphery of the first wire; and a tubular second shield that surrounds an outer periphery of a portion of the first shield and an outer periphery of the second wire, the portion of the first shield surrounding the outer periphery of the connection.

### BACKGROUND

The present disclosure relates to a wire harness and a method for manufacturing a wire harness.

Wire harnesses that include tubular shield members that collectively surround outer peripheries of a plurality of wires are conventionally known as wire harnesses installed inside vehicles such as hybrid vehicles and electric vehicles (see JP 2004-171952A, for example). The shield members have an electromagnetic shielding function of suppressing the radiation of electromagnetic waves from wires to the outside of the wire harnesses.

### SUMMARY

There is demand for suppressing a reduction in the electromagnetic shielding performance of the wire harnesses described above, and there is still room for improvement in this respect.

An exemplary aspect of the disclosure provides a wire harness that can suppress a reduction in the electromagnetic shielding performance.

A wire harness according to the present disclosure includes: a first wire that is electrically connectable to a first connector installed in a vehicle; a second wire that is electrically connected to the first wire; a third wire that is electrically connected to the first wire; a connection where the first wire, the second wire, and the third wire are electrically connected to each other; a tubular first shield that surrounds an outer periphery of the connection and an outer periphery of the first wire; and a tubular second shield that surrounds an outer periphery of a portion of the first shield and an outer periphery of the second wire, the portion of the first shield surrounding the outer periphery of the connection.

A method for manufacturing a wire harness according to the present disclosure includes: forming a wire assembly that includes a first wire, a second wire, a third wire, and a connection where the first wire, the second wire, and the third wire are electrically connected to each other; housing the wire assembly in its entirety in a tubular first shield; forming a first opening in an intermediate portion in an axial direction of the first shield; forming a first structure by drawing a second-wire-side second end of the second wire to an outside of the first shield from the first opening, the second-wire-side second end being opposite to a second-wire-side first end of the second wire that is connected to the connection; housing the first structure in its entirety in a tubular second shield; forming a second opening in an intermediate portion in an axial direction of the second shield; and drawing a portion of the first shield to an outside of the second shield from the second opening, the portion of the first shield surrounding an outer periphery of the third wire in the first structure, wherein an outer periphery of the connection is surrounded by the first shield, and an outer periphery of a portion of the first shield is surrounded by the second shield, the portion of the first shield surrounding the outer periphery of the connection.

The wire harness and the method for manufacturing a wire harness according to the present disclosure have an effect of suppressing a reduction in the electromagnetic shielding performance.

### BRIEF DESCRIPTION OF THE DRAWINGS

FIG. 1 is a schematic configuration diagram showing a wire harness according to an embodiment;

FIG. 2 is a schematic configuration diagram showing the wire harness according to an embodiment;

FIG. 3 is a schematic configuration diagram showing the wire harness according to an embodiment;

FIG. 4 is a schematic cross-sectional view (cross-sectional view taken along line 4-4 in FIGS. 2 and 3) showing the wire harness according to an embodiment;

FIG. 5 is a schematic cross-sectional view (cross-sectional view taken along line 5-5 in FIGS. 2 and 3) showing the wire harness according to an embodiment;

FIG. 6 is a schematic cross-sectional view (cross-sectional view taken along line 6-6 in FIGS. 2 and 3) showing the wire harness according to an embodiment;

FIG. 7 is a schematic configuration diagram showing a method for manufacturing a wire harness according to an embodiment;

FIG. 8 is a schematic configuration diagram showing the method for manufacturing a wire harness according to an embodiment;

FIG. 9 is a schematic configuration diagram showing the method for manufacturing a wire harness according to an embodiment;

FIG. 10 is a schematic configuration diagram showing the method for manufacturing a wire harness according to an embodiment;

FIG. 11 is a schematic configuration diagram showing the method for manufacturing a wire harness according to an embodiment;

FIG. 12 is a schematic configuration diagram showing the method for manufacturing a wire harness according to an embodiment;

FIG. 13 is a schematic configuration diagram showing the method for manufacturing a wire harness according to an embodiment;

FIG. 14 is a schematic configuration diagram showing the method for manufacturing a wire harness according to an embodiment;

FIG. 15 is a schematic configuration diagram showing a wire harness according to a variation; and

FIG. 16 is a schematic configuration diagram showing a wire harness according to a variation.

### DETAILED DESCRIPTION OF EMBODIMENTS

First, embodiments of the present disclosure will be listed and described.

[1] A wire harness according to the present disclosure includes: a first wire that is electrically connectable to a first connector installed in a vehicle; a second wire that is electrically connected to the first wire; a third wire that is electrically connected to the first wire; a connection portion in which the first wire, the second wire, and the third wire are electrically connected to each other; a tubular first shield member that surrounds the outer periphery of the connection portion and the outer periphery of the first wire; and a tubular second shield member that surrounds the outer periphery of a portion of the first shield member and the outer periphery of the second wire, the portion of the first shield member surrounding the outer periphery of the connection portion.

This configuration includes the tubular first shield member that surrounds the outer periphery of the connection portion in which the first wire, the second wire, and the third wire are electrically connected to each other. The configuration further includes the tubular second shield member that surrounds the outer periphery of the portion of the first shield member surrounding the outer periphery of the connection portion. Accordingly, the outer periphery of the connection portion is surrounded by the first shield member, and the outer periphery of the first shield member is surrounded by the second shield member. Thus, the outer periphery of the connection portion is surrounded by both the first shield member and the second shield member. Therefore, even when one of the first shield member and the second shield member is damaged, for example, the other of the first shield member and the second shield member can serve as an electromagnetic shield for the connection portion. Therefore, it is possible to favorably suppress a reduction in the electromagnetic shielding performance in the connection portion. Consequently, the radiation of electromagnetic waves (electromagnetic noise) generated in the connection portion to the outside of the wire harness can be favorably suppressed.

Here, the axial direction of the first shield member is the direction in which the center axis of the first shield member extends, and the axial direction of the second shield member is the direction in which the center axis of the second shield member extends. “Tubular” as used in the description of the present specification means not only the shape of a peripheral wall that is continuously formed over the entire circumferential direction thereof but also a tubular shape formed by a plurality of combined parts and a shape in which a portion in the circumferential direction thereof includes a notch or the like, such as a C-shape. Also, “tubular” shapes include circular shapes, elliptical shapes, and polygonal shapes including angular or rounded corners.

[2] It is preferable that: the first shield member surrounds the outer periphery of a portion of the second wire; the first shield member includes a first opening that is provided in an intermediate portion in an axial direction of the first shield member; the second wire includes a second-wire-side first end portion that is connected to the connection portion and a second-wire-side second end portion that is opposite to the second-wire-side first end portion; the second-wire-side second end portion of the second wire is drawn to the outside of the first shield member from the first opening; and the second shield member surrounds the outer periphery of a portion of the first shield member and the outer periphery of the second wire exposed from the first shield member, the portion of the first shield member surrounding the outer periphery of the second wire. In this configuration, the outer periphery of a portion of the second wire is surrounded by the first shield member, and the outer periphery of the portion of the first shield member surrounding the outer periphery of the second wire is surrounded by the second shield member. Accordingly, the outer periphery of the portion of the second wire is surrounded by both the first shield member and the second shield member. Therefore, even when one of the first shield member and the second shield member is damaged, for example, the other of the first shield member and the second shield member can serve as an electromagnetic shield for the second wire. Consequently, a reduction in the electromagnetic shielding performance with respect to the second wire can be favorably suppressed. Also, the outer periphery of the second wire exposed from the first shield member is surrounded by the second shield member. Therefore, the second shield member serves as an electromagnetic shield for the second wire drawn to the outside of the first shield member from the first opening. Therefore, it is possible to favorably suppress a reduction in the electromagnetic shielding performance in the portion exposed from the first shield member.

[3] It is preferable that: the first shield member surrounds the outer periphery of the third wire; the first shield member includes a first-shield-side first end portion that surrounds the outer periphery of the first wire and a first-shield-side second end portion that is opposite to the first-shield-side first end portion in the axial direction of the first shield member; the second shield member surrounds the outer periphery of a portion of the first shield member in a portion in which the first shield member surrounds the outer periphery of the third wire; the second shield member includes a second opening that is provided in an intermediate portion in an axial direction of the second shield member; and the first-shield-side second end portion of the first shield member is drawn to the outside of the second shield member from the second opening in the state of surrounding the outer periphery of the third wire. In this configuration, the outer periphery of the third wire is surrounded by the first shield member, and in the portion in which the first shield member surrounds the outer periphery of the third wire, the outer periphery of a portion of the first shield member is surrounded by the second shield member. Accordingly, the outer periphery of a portion of the third wire is surrounded by both the first shield member and the second shield member. Therefore, even when one of the first shield member and the second shield member is damaged, for example, the other of the first shield member and the second shield member can serve as an electromagnetic shield for the third wire. Consequently, a reduction in the electromagnetic shielding performance with respect to the third wire can be favorably suppressed. Also, the first-shield-side second end portion of the first shield member is drawn to the outside of the second shield member from the second opening in the state of surrounding the outer periphery of the third wire. Accordingly, the portion of the third wire drawn to the outside of the second shield member is surrounded by the first shield member, which serves as an electromagnetic shield for the portion. Therefore, it is possible to favorably suppress a reduction in the electromagnetic shielding performance in the portion exposed from the second shield member.

[4] It is preferable that: the second shield member surrounds the outer periphery of a portion of the first shield member in a portion in which the first shield member surrounds the outer periphery of the first wire; the second shield member includes a third opening that is provided in an intermediate portion in the axial direction of the second shield member; and the first-shield-side first end portion of the first shield member is drawn to the outside of the second shield member from the third opening in the state of surrounding the outer periphery of the first wire. In this configuration, the outer periphery of the first wire is surrounded by the first shield member, and the outer periphery of a portion of the first shield member is surrounded by the second shield member in the portion in which the first shield member surrounds the outer periphery of the first wire. Accordingly, the outer periphery of a portion of the first wire is surrounded by both the first shield member and the second shield member. Therefore, even when one of the first shield member and the second shield member is damaged, for example, the other of the first shield member and the second shield member can serve as an electromagnetic shield for the first wire. Consequently, a reduction in the electromagnetic shielding performance with respect to the first wire can be favorably suppressed. Also, the first-shield-side first end portion of the first shield member is drawn to the outside of the second shield member from the third opening in the state of surrounding the outer periphery of the first wire. Accordingly, the portion of the first wire drawn to the outside of the second shield member is surrounded by the first shield member, which serves as an electromagnetic shield for the portion. Therefore, it is possible to favorably suppress a reduction in the electromagnetic shielding performance in the portion exposed from the second shield member.

[5] It is preferable that the first wire is an unshielded wire that does not have its own electromagnetic shielding structure, the second wire is an unshielded wire that does not have its own electromagnetic shielding structure, and the third wire is an unshielded wire that does not have its own electromagnetic shielding structure. In this configuration, the outer peripheries of the first wire, the second wire, and the third wire, which are unshielded wires, are surrounded by the first shield member and the second shield member.

Therefore, the first shield member and the second shield member can favorably serve as electromagnetic shields for the first wire, the second wire, and the third wire. In other words, even in the case where the first wire, the second wire, and the third wire are unshielded wires, the first shield member and the second shield member serve as electromagnetic shields for the first wire, the second wire, and the third wire, and therefore, it is possible to favorably suppress a reduction in the electromagnetic shielding performance in the wire harness.

[6] It is preferable that: the first-shield-side first end portion of the first shield member includes a first separated portion that does not surround the outer periphery of the first wire and extends away from the first wire; and the wire harness further includes a grounding member that is electrically connected to a leading end of the first separated portion and is electrically connected to a grounding portion provided in the vehicle. In this configuration, the grounding member is electrically connected to the leading end of the first separated portion provided in the first-shield-side first end portion of the first shield member. Also, the grounding member is electrically connected to the grounding portion provided in the vehicle. Accordingly, the leading end of the first separated portion can be electrically connected to the grounding portion via the grounding member. Consequently, the first shield member can favorably function as an electromagnetic shield member.

[7] It is preferable that: a second-shield-side first end portion in the axial direction of the second shield member includes a second separated portion that does not surround the outer periphery of the first wire and extends away from the first wire; a leading end of the second separated portion is electrically connected to the grounding member; and the grounding member electrically connects the leading end of the first separated portion and the leading end of the second separated portion collectively to the grounding portion. In this configuration, the leading end of the first separated portion of the first shield member and the leading end of the second separated portion of the second shield member are collectively electrically connected to the grounding portion. Therefore, when compared with a case where the leading end of the first separated portion and the leading end of the second separated portion are electrically connected to different grounding portions, the number of connections to grounding portions, i.e., the number of grounding sites can be reduced.

[8] It is preferable that the first connector is electrically connectable to an external connector that is connected to an external power source. In this configuration, the first connector that is electrically connected to the first wire is electrically connected to the external connector and the external power source. In the wire harness of this case, a large current flows through the first wire electrically connected to the first connector, and accordingly, electromagnetic noise is likely to be generated in the first wire and the connection portion, for example. However, in the wire harness of the present disclosure, the outer periphery of the connection portion is surrounded by both the first shield member and the second shield member to suppress a reduction in the electromagnetic shielding performance in the connection portion. Therefore, even in the case where electromagnetic noise is likely to be generated, it is possible to favorably suppress the radiation of electromagnetic noise generated from the connection portion to the outside of the wire harness.

[9] A method for manufacturing a wire harness according to the present disclosure includes: forming a wire assembly that includes a first wire, a second wire, a third wire, and a connection portion in which the first wire, the second wire, and the third wire are electrically connected to each other; housing the entire wire assembly in a tubular first shield member; forming a first opening in an intermediate portion in an axial direction of the first shield member; forming a first structure by drawing a second-wire-side second end portion of the second wire to the outside of the first shield member from the first opening, the second-wire-side second end portion being opposite to a second-wire-side first end portion of the second wire that is connected to the connection portion; housing the entire first structure in a tubular second shield member; forming a second opening in an intermediate portion in an axial direction of the second shield member; and drawing a portion of the first shield member to the outside of the second shield member from the second opening, the portion of the first shield member surrounding the outer periphery of the third wire in the first structure, wherein the outer periphery of the connection portion is surrounded by the first shield member, and the outer periphery of a portion of the first shield member is surrounded by the second shield member, the portion of the first shield member surrounding the outer periphery of the connection portion.

In this configuration, the outer periphery of the connection portion is surrounded by both the first shield member and the second shield member. Therefore, even when one of the first shield member and the second shield member is damaged, for example, the other of the first shield member and the second shield member can serve as an electromagnetic shield for the connection portion. Therefore, it is possible to favorably suppress a reduction in the electromagnetic shielding performance in the connection portion.

[10] It is preferable that: the wire assembly includes a plurality of the first wires, a plurality of the second wires, a plurality of the third wires, and a plurality of the connection portions; and in the forming the wire assembly, a common seal member is attached to the second-wire-side second end portions of the plurality of second wires. In this configuration, the common seal member is attached to the second-wire-side second end portions of the plurality of second wires. Therefore, the second-wire-side second end portions of the plurality of second wires are drawn to the outside of the first shield member from the first opening in the state where the plurality of second wires are bundled together using the seal member. This improves ease of work when assembling the wire harness when compared with a case where the plurality of second wires that are not bundled together are drawn out from the first opening.

### Details of Embodiments of the Present Invention

A specific example of a wire harness according to the present disclosure will be described below with reference to the drawings. In the drawings, a portion of the configuration may be emphasized or simplified for the sake of convenience of description. Dimensional ratios of portions may differ between drawings. “Orthogonal” as used in the present specification encompasses not only the strict sense of the word “orthogonal” but also the meaning of “substantially orthogonal” within a range in which operations and effects of the present embodiment can be achieved. Note that the present invention is not limited to the following examples, but is defined by the claims, and is intended to encompass all modifications within the meanings and scope that are equivalent to the claims

### Overall Configuration of Wire Harness 1

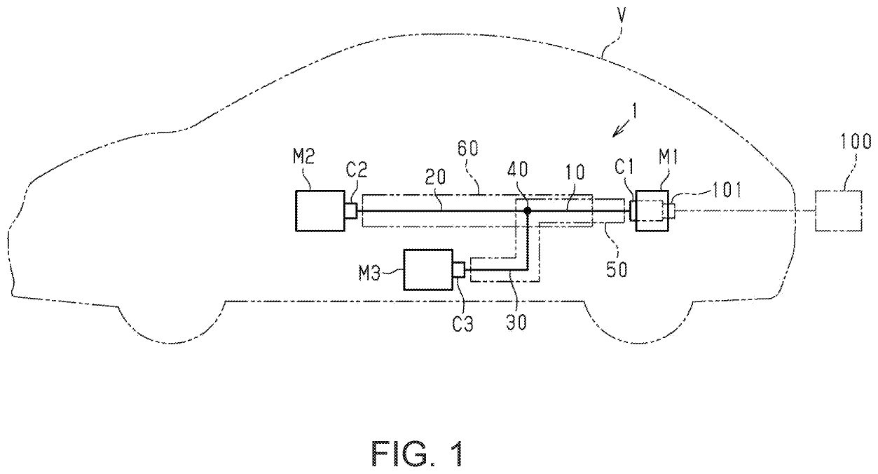

A wire harness 1 shown in FIG. 1 is installed in a vehicle V such as a hybrid vehicle or an electric vehicle, for example. The wire harness 1 electrically connects three or more in-vehicle devices. The in-vehicle devices are electrical devices installed in the vehicle V. The wire harness 1 of the present embodiment electrically connects a charging inlet M1 and a plurality of in-vehicle devices M2 and M3. The wire harness 1 is formed into an elongated shape so as to extend in the front-rear direction of the vehicle V, for example.

In the present embodiment, in the length direction of the wire harness 1, the side close to the charging inlet M1 will be referred to as the “rear side”, and the side close to the in-vehicle devices M2 and M3 will be referred to as the “front side” for the sake of convenience of description. Also, the charging inlet M1 side end portion of each member will be referred to as the “rear end portion”, and the in-vehicle device M2, M3 side end portion of each member will be referred to as the “front end portion”.

The wire harness 1 includes a wire 10, wires 20 and 30 that are electrically connected to the wire 10, and a connection portion 40 (connection) in which the wire 10 is connected to the wires 20 and 30, for example. The wire harness 1 includes a tubular shield member 50 that surrounds the outer periphery of the connection portion 40 and the outer periphery of the wire 10 and a tubular shield member 60 that surrounds the outer periphery of the connection portion 40 and the outer periphery of the wire 20. The wire harness 1 includes a connector C1 that is attached to the rear end portion of the wire 10, a connector C2 that is attached to the front end portion of the wire 20, and a connector C3 that is attached to the front end portion of the wire 30, for example.

The connector C1 is provided in the charging inlet M1, for example. The connector C1 constitutes a portion of the charging inlet M1, for example. In other words, the charging inlet M1 includes the connector C1. The connector C1 constituting the charging inlet M1 is electrically connectable to an external connector 101 that is connected to an external power source 100. The connector C2 is electrically connected to the in-vehicle device M2. The connector C3 is electrically connected to the in-vehicle device M3. The in-vehicle devices M2 and M3 are batteries, for example. The batteries are secondary batteries such as lithium-ion batteries, for example. It is possible to charge the batteries with power supplied from the external power source 100 by connecting the external connector 101 to the connector C1 of the charging inlet Ml, for example. The battery capacity of the vehicle V can be increased by connecting a plurality of batteries to the charging inlet M1. As described above, the wire harness 1 of the present embodiment is a wire harness for charging that connects the in-vehicle devices M2 and M3, which are batteries, to the charging inlet M1.

In the wire harness 1, the two wires 20 and 30 branch from the single wire 10 at an intermediate portion in the length direction of the wire harness 1. In the wire harness 1 of the present embodiment, power supplied from the charging inlet M1 is distributed to the wires 20 and 30 and supplied via the wires 20 and 30 to the in-vehicle devices M2 and M3, which are batteries. In the wire harness 1, the wire 10 functions as a trunk wire and the wires 20 and 30 function as branch wires, for example. The wires 10, 20, and 30 are high-voltage wires that can withstand high voltages and large currents, for example.

### Configuration of Wire 10

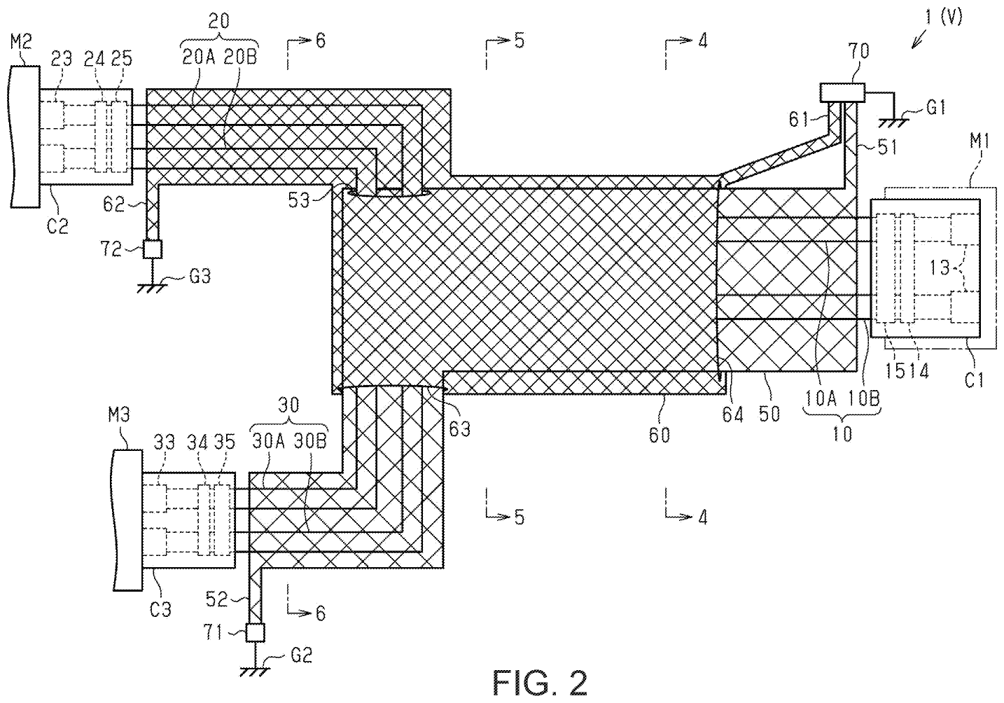

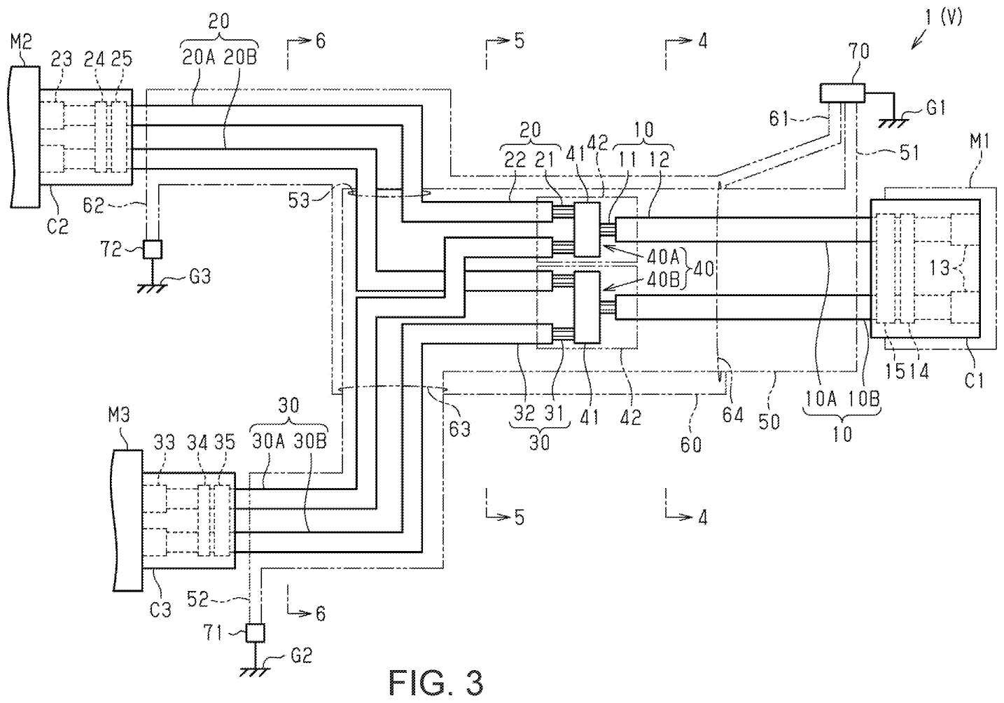

As shown in FIGS. 2 and 3, the wire 10 includes a plus side wire 10A and a minus side wire 10B, for example.

### Configuration of Wires 10A and 10B

As shown in FIG. 3, each of the wires 10A and 10B includes a conductive core wire 11 and an insulating covering 12 that surrounds the outer periphery of the core wire 11 and has insulating properties. The wires 10A and 10B are unshielded wires that do not have their own electromagnetic shielding structures, for example. The wires 10A and 10B are formed into elongated shapes so as to extend in the front-rear direction of the vehicle V, for example.

A twisted wire that is obtained by twisting a plurality of metal strands or a single core wire that is constituted by a single conductor can be used as the core wire 11, for example. A columnar conductor that is constituted by a single columnar metal rod having a solid structure or a tubular conductor that has a hollow structure can be used as the single core wire, for example. Any combination of a twisted wire, a columnar conductor, and a tubular conductor may also be used as the core wire 11. The core wire 11 in the present embodiment is a twisted wire. Metal materials such as copper-based materials and aluminum-based materials can be used as the material of the core wire 11, for example.

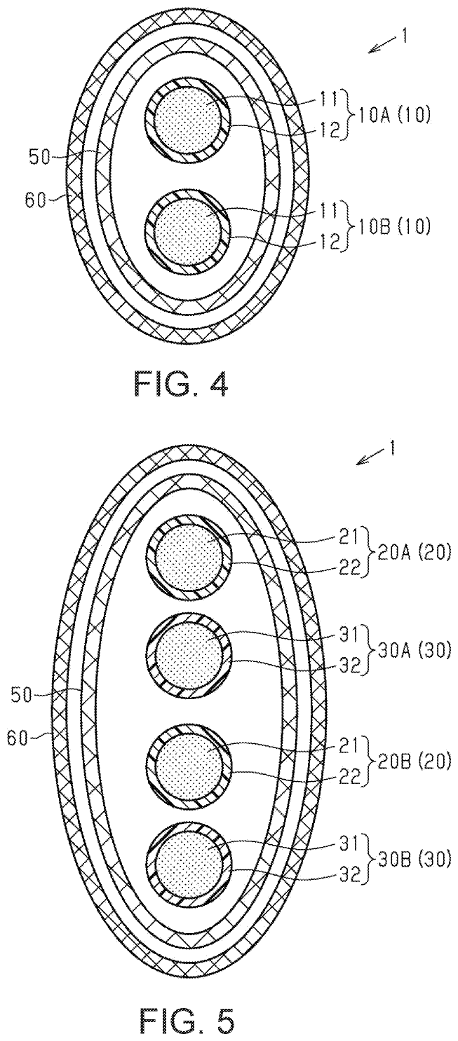

As shown in FIG. 4, the insulating covering 12 covers the outer circumferential surface of the core wire 11 over its entire circumference, for example. The insulating covering 12 is made of a resin material that has insulating properties, for example.

The shapes of cross sections of the wires 10A and 10B taken along a plane orthogonal to the length directions of the wires 10A and 10B, i.e., the shapes of transverse cross sections of the wires 10A and 10B may be any shape. The shapes of transverse cross sections of the wires 10A and 10B are circular shapes in the present embodiment.

### Structure of End Portions in Length Direction of Wires 10A and 10B

As shown in FIG. 3, the front end portion of the core wire 11 is exposed from the insulating covering 12 at the front end portion of each of the wires 10A and 10B. At the front end portion of each of the wires 10A and 10B, the insulating covering 12 is removed by a predetermined length from the end of the wire 10A or 10B to expose the front end portion of the core wire 11.

The rear end portions of the wires 10A and 10B are housed in the connector C1, for example. At the rear end portion of each of the wires 10A and 10B, the rear end portion of the core wire 11 exposed from the insulating covering 12 is electrically connected to a metal terminal 13, although this is not illustrated in detail. The terminal 13 is electrically connected to a terminal of the external connector 101 (see FIG. 1), for example. At the rear end portions of the wires 10A and 10B, a ring-shaped seal member 14 and a retainer 15 that keeps the seal member 14 from coming loose from the connector Cl are attached to the outer circumferential surfaces of the rear end portions of the insulating coverings 12. The seal member 14 is common to the two wires 10A and 10B, for example. That is, the single seal member 14 is attached to the two wires 10A and 10B. The seal member 14 seals a gap between the outer circumferential surfaces of the wires 10A and 10B and the inner circumferential surface of the connector C1. The seal member 14 is made of rubber, for example. The retainer 15 is common to the two wires 10A and 10B, for example.

### Configuration of Wire 20

The wire 20 includes a plus side wire 20A that is connected to the plus terminal of the in-vehicle device M2 and a minus side wire 20B that is connected to the minus terminal of the in-vehicle device M2, for example.

### Configuration of Wires 20A and 20B

Each of the wires 20A and 20B includes a conductive core wire 21 and an insulating covering 22 that surrounds the outer periphery of the core wire 21 and has insulating properties. The wires 20A and 20B are unshielded wires, for example. The wires 20A and 20B are formed into elongated shapes so as to extend in the front-rear direction of the vehicle V, for example.

A twisted wire, a columnar conductor, or a tubular conductor can be used as the core wire 21, for example. Any combination of a twisted wire, a columnar conductor, and a tubular conductor may also be used as the core wire 21. The core wire 21 in the present embodiment is a twisted wire. Metal materials such as copper-based materials and aluminum-based materials can be used as the material of the core wire 21, for example.

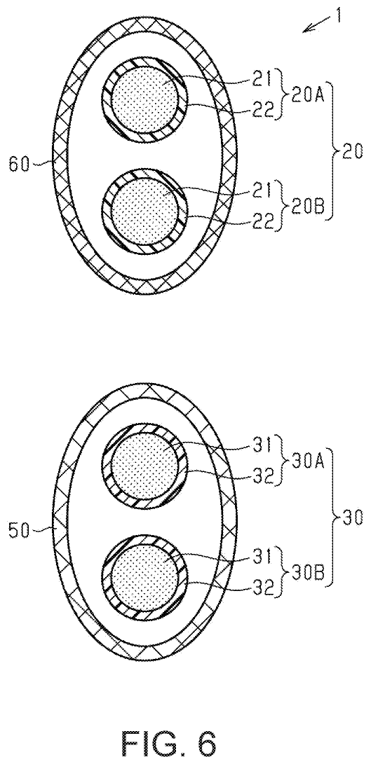

As shown in FIGS. 5 and 6, the insulating covering 22 covers the outer circumferential surface of the core wire 21 over its entire circumference, for example. The insulating covering 22 is made of a resin material that has insulating properties, for example.

The shapes of transverse cross sections of the wires 20A and 20B may be any shape. The shapes of transverse cross sections of the wires 20A and 20B are circular shapes in the present embodiment.

Structure of End Portions in Length Direction of Wires 20A and 20B

As shown in FIG. 3, the rear end portion of the core wire 21 is exposed from the insulating covering 22 at the rear end portion of each of the wires 20A and 20B. At the rear end portion of each of the wires 20A and 20B, the insulating covering 22 is removed by a predetermined length from the end of the wire 20A or 20B to expose the rear end portion of the core wire 21.

The front end portions of the wires 20A and 20B are housed in the connector C2, for example. At the front end portion of each of the wires 20A and 20B, the front end portion of the core wire 21 exposed from the insulating covering 22 is electrically connected to a metal terminal 23, although this is not illustrated in detail. At the front end portions of the wires 20A and 20B, a ring-shaped seal member 24 and a retainer 25 that keeps the seal member 24 from coming loose from the connector C2 are attached to the outer circumferential surfaces of the front end portions of the insulating coverings 22. The seal member 24 is common to the two wires 20A and 20B, for example. That is, the single seal member 24 is attached to the two wires 20A and 20B. The seal member 24 seals a gap between the outer circumferential surfaces of the wires 20A and 20B and the inner circumferential surface of the connector C2. The seal member 24 is made of rubber, for example. The retainer 25 is common to the two wires 20A and 20B, for example.

### Configuration of Wire 30

The wire 30 includes a plus side wire 30A that is connected to the plus terminal of the in-vehicle device M3 and a minus side wire 30B that is connected to the minus terminal of the in-vehicle device M3, for example.

### Configuration of Wires 30A and 30B

Each of the wires 30A and 30B includes a conductive core wire 31 and an insulating covering 32 that surrounds the outer periphery of the core wire 31 and has insulating properties. The wires 30A and 30B in the present embodiment are unshielded wires, for example. The wires 30A and 30B are formed into elongated shapes so as to extend in the front-rear direction of the vehicle V, for example.

A twisted wire, a columnar conductor, or a tubular conductor can be used as the core wire 31, for example. Any combination of a twisted wire, a columnar conductor, and a tubular conductor may also be used as the core wire 31. The core wire 31 in the present embodiment is a twisted wire. Metal materials such as copper-based materials and aluminum-based materials can be used as the material of the core wire 31, for example.

As shown in FIGS. 5 and 6, the insulating covering 32 covers the outer circumferential surface of the core wire 31 over its entire circumference, for example. The insulating covering 32 is made of a resin material that has insulating properties, for example.

The shapes of transverse cross sections of the wires 30A and 30B may be any shape. The shapes of transverse cross sections of the wires 30A and 30B are circular shapes in the present embodiment.

### Structure of End Portions in Length Direction of Wires 30A and 30B

As shown in FIG. 3, the rear end portion of the core wire 31 is exposed from the insulating covering 32 at the rear end portion of each of the wires 30A and 30B. At the rear end portion of each of the wires 30A and 30B, the insulating covering 32 is removed by a predetermined length from the end of the wire 30A or 30B to expose the rear end portion of the core wire 31.

The front end portions of the wires 30A and 30B are housed in the connector C3, for example. At the front end portion of each of the wires 30A and 30B, the front end portion of the core wire 31 exposed from the insulating covering 32 is electrically connected to a metal terminal 33, although this is not illustrated in detail. At the front end portions of the wires 30A and 30B, a ring-shaped seal member 34 and a retainer 35 that keeps the seal member 34 from coming loose from the connector C3 are attached to the outer circumferential surfaces of the front end portions of the insulating coverings 32. The seal member 34 is common to the two wires 30A and 30B, for example. That is, the single seal member 34 is attached to the two wires 30A and 30B. The seal member 34 seals a gap between the outer circumferential surfaces of the wires 30A and 30B and the inner circumferential surface of the connector C3. The seal member 34 is made of rubber, for example. The retainer 35 is common to the two wires 30A and 30B, for example.

### Configuration of Connection Portion 40

The connection portion 40 includes a connection portion 40A in which the plus side wire 10A is connected to the plus side wires 20A and 30A and a connection portion 40B in which the minus side wire 10B is connected to the minus side wires 20B and 30B, for example. Here, the connection portion 40A and the connection portion 40B have the same structure, and therefore, the connection portions 40A and 40B will be collectively referred to as the connection portion 40. Likewise, the wires 10A and 10B will be collectively referred to as the wire 10, the wires 20A and 20B will be collectively referred to as the wire 20, and the wires 30A and 30B will be collectively referred to as the wire 30.

In the connection portion 40, the core wire 11 of the wire 10 is electrically connected to the core wire 21 of the wire 20 and the core wire 31 of the wire 30. In the connection portion 40, the front end portion of the core wire 11 exposed from the insulating covering 12, the rear end portion of the core wire 21 exposed from the insulating covering 22, and the rear end portion of the core wire 31 exposed from the insulating covering 32 are joined to each other. There is no particular limitation on the method for joining the core wires 11, 21, and 31. For example, the core wires 11, 21, and 31 can be joined by being crimped using a crimp terminal or welded through ultrasonic welding or laser welding, or using any other known joining method. In the present embodiment, the core wires 11, 21, and 31 are joined by being crimped using a crimp terminal 41.

### Configuration of Covering Member 42

The wire harness 1 includes a plurality of covering members 42 that cover the outer periphery of the connection portion 40A and the outer periphery of the connection portion 40B individually, for example.

Each covering member 42 has an elongated tubular shape, for example. Each covering member 42 covers the outer periphery of the crimp terminal 41, the core wire 11 exposed from the insulating covering 12, the core wire 21 exposed from the insulating covering 22, and the core wire 31 exposed from the insulating covering 32, for example. Each covering member 42 is formed so as to span between the front end portion of the insulating covering 12 and the rear end portions of the insulating coverings 22 and 32. For example, the rear end portion of each covering member 42 covers the outer circumferential surface of the front end portion of the insulating covering 12, and the front end portion of each covering member 42 covers the outer circumferential surfaces of the rear end portions of the insulating coverings 22 and 32. Each covering member 42 surrounds the outer periphery of the wire 10, the outer periphery of the wire 20, the outer periphery of the wire 30, and the outer periphery of the crimp terminal 41 over their entire circumferences. Each covering member 42 has a function of maintaining electrical insulation of the connection portion 40 and the core wires 11, 21, and 31 exposed from the insulating coverings 12, 22, and 32, for example.

As the covering members 42, it is possible to use shrinkable tubes, rubber tubes, resin molded articles, hot-melt adhesive, or tape members, for example. The covering members 42 in the present embodiment are heat-shrinkable tubes. As the material of the covering members 42, it is possible to use a synthetic resin that contains a polyolefin resin such as cross-linked polyethylene or cross-linked polypropylene as the main component, for example.

### Configuration of Shield Member 50

The shield member 50 has an elongated tubular shape, for example. The shield member 50 is flexible, for example. A braided wire that is obtained by braiding a plurality of metal strands into a tubular shape or a metal foil can be used as the shield member 50, for example. The shield member 50 in the present embodiment is a braided wire. Metal materials such as copper-based materials and aluminum-based materials can be used as the material of the shield member 50, for example.

The shield member 50 is arranged to surround the outer periphery of the connection portion 40. The shield member 50 is arranged to surround the outer peripheries of the connection portions 40A and 40B collectively. The shield member 50 surrounds the outer peripheries of the plurality of covering members 42 over their entire circumferences, for example.

In the present specification, “surround a member A and a member B collectively” means to surround the member A and the member B together using a single tubular member without providing a wall between the member A and the member B, for example.

As shown in FIGS. 3 and 4, the shield member 50 collectively surrounds the outer peripheries of the plurality of wires 10, i.e., the wires 10A and 10B, for example. The shield member 50 surrounds the outer peripheries of the wires 10A and 10B over their entire circumferences, for example. As shown in FIG. 3, the shield member 50 surrounds the outer peripheries of the wires 10A and 10B over the entire lengths of the wires 10A and 10B in their length directions, for example. The “entire length” as used in the present specification encompasses not only the strict sense of the word “entire length” but also the meaning of “substantially the entire length” within a range in which operations and effects of the present embodiment can be achieved.

As shown in FIGS. 3 and 6, the shield member 50 collectively surrounds the outer peripheries of the plurality of wires 30, i.e., the wires 30A and 30B, for example. The shield member 50 surrounds the outer peripheries of the wires 30A and 30B over their entire circumferences, for example. As shown in FIG. 3, the shield member 50 surrounds the outer peripheries of the wires 30A and 30B over the entire lengths of the wires 30A and 30B in their length directions, for example. The shield member 50 surrounds the outer peripheries of the insulating coverings 32 exposed from the covering members 42, for example.

The shield member 50 surrounds the outer peripheries of portions of the wires 20A and 20B in their length directions, for example. The shield member 50 surrounds the outer peripheries of the rear end portions of the wires 20A and 20B, for example. The shield member 50 surrounds the outer peripheries of the rear end portions of the insulating coverings 22 exposed from the covering members 42, for example. The shield member 50 collectively surrounds the outer peripheries of the rear end portions of the four wires 20A, 20B, 30A, and 30B exposed from the covering members 42, for example. As shown in FIG. 5, the shield member 50 surrounds the outer peripheries of the rear end portions of the four wires 20A, 20B, 30A, and 30B over their entire circumferences, for example.

As shown in FIGS. 2 and 3, the shield member 50 of the present embodiment is formed so as to surround a region in the length direction of the wire harness 1 from the rear end portions of the wires 10A and 10B to the front end portions of the wires 30A and 30B.

### Grounding Structure of Shield Member 50

The shield member 50 is electrically connected to grounding portions of the vehicle V, e.g., grounding portions provided in a vehicle body panel or the like. That is, the shield member 50 is grounded to the grounding portions. Both end portions in the axial direction (length direction) of the shield member 50 are grounded, for example. The following describes an example of the grounding structure of the shield member 50.

The rear end portion of the shield member 50 includes a separated portion 51 that does not surround the outer periphery of the wire 10 and extends away from the wire 10. The separated portion 51 extends in a direction (upward in the drawing) that intersects the length direction of the wire 10, for example. The leading end of the separated portion 51 is electrically connected to a metal earth terminal 70, for example. The earth terminal 70 is electrically connected to a grounding portion G1 provided in the vehicle body panel or the like, for example. The leading end of the separated portion 51 is grounded to the grounding portion G1 via the earth terminal 70, for example. Here, the leading end of the separated portion 51 is the end portion that is the farthest from the wire 10, out of end portions in the axial direction of the separated portion 51. The separated portion 51 and the earth terminal 70 can be joined by being crimped or welded through ultrasonic welding or laser welding, or using any other known joining method.

The front end portion of the shield member 50 includes a separated portion 52 that does not surround the outer periphery of the wire 30 and extends away from the wire 30. The separated portion 52 extends in a direction (downward in the drawing) that intersects the length direction of the wire 30, for example. The leading end of the separated portion 52 is electrically connected to a metal earth terminal 71, for example. The leading end of the separated portion 52 is grounded to a grounding portion G2 provided in the vehicle body panel or the like via the earth terminal 71, for example. Here, the leading end of the separated portion 52 is the end portion that is the farthest from the wire 30, out of end portions in the axial direction of the separated portion 52. The separated portion 52 and the earth terminal 71 can be joined by being crimped or welded through ultrasonic welding or laser welding, or using any other known joining method.

With the configuration described above, the shield member 50 exhibits an electromagnetic shielding function of suppressing the radiation of electromagnetic waves from the wires 10, 20, and 30 and the connection portion 40 to the outside of the wire harness 1.

### Configuration of Opening 53

The shield member 50 includes an opening 53 that is provided in an intermediate portion in the axial direction of the shield member 50. The opening 53 is formed to pass through the shield member 50 in the radial direction of the shield member 50, for example. The opening 53 is formed by widening a mesh in the shield member 50, which is a braided wire, for example. For example, the opening 53 is formed by widening a single mesh in the shield member 50. The opening 53 is formed such that the two wires 20A and 20B can pass through the opening 53, for example. Here, the number of openings 53 can be set to a suitable number. For example, a single opening 53 may be provided as in the illustrated case. In this case, the two wires 20A and 20B pass through the single opening 53. The number of openings 53 may be changed to two or more. In the case where two openings 53 are provided, for example, the two wires 20A and 20B respectively pass through the two openings 53.

The front end portions of the two wires 20A and 20B passing through the opening 53 are drawn to the outside of the shield member 50. The front end portions of the wires 20A and 20B drawn to the outside of the shield member 50 are exposed from the shield member 50. Accordingly, the shield member 50 does not serve as an electromagnetic shield for the front end portions of the wires 20A and 20B.

### Configuration of Shield Member 60

The shield member 60 has an elongated tubular shape, for example. The shield member 60 is flexible, for example. A braided wire or a metal foil can be used as the shield member 60, for example. The shield member 60 in the present embodiment is a braided wire. Metal materials such as copper-based materials and aluminum-based materials can be used as the material of the shield member 60, for example.

As shown in FIG. 3, the shield member 60 is arranged to surround the outer periphery of the connection portion 40. The shield member 60 is arranged to collectively surround the outer peripheries of the two connection portions 40A and 40B. The shield member 60 surrounds the outer peripheries of the connection portions 40A and 40B and the covering members 42 over their entire circumferences, for example. The shield member 60 surrounds the outer periphery of a portion of the shield member 50 surrounding the outer peripheries of the plurality of connection portions 40. The shield member 60 surrounds the outer periphery of a portion of the shield member 50 surrounding the outer peripheries of the plurality of covering members 42, for example. Accordingly, the outer peripheries of the connection portions 40 and the covering members 42 are surrounded by both the shield member 50 and the shield member 60.

The shield member 60 collectively surrounds the outer peripheries of the plurality of wires 20, i.e., the wires 20A and 20B. The shield member 60 surrounds the outer peripheries of the wires 20A and 20B over their entire circumferences, for example. The shield member 60 surrounds the outer peripheries of the wires 20A and 20B over the entire lengths of the wires 20A and 20B in their length directions, for example. The shield member 60 collectively surrounds the outer peripheries of the front end portions of the wires 20A and 20B drawn to the outside of the shield member 50 from the opening 53, for example. As shown in FIGS. 3 and 6, the outer peripheries of the front end portions of the wires 20A and 20B are surrounded by only the shield member 60 out of the shield members 50 and 60.

As shown in FIG. 3, the shield member 60 collectively surrounds the outer peripheries of portions of the plurality of wires 30, i.e., the wires 30A and 30B in their length directions, for example. The shield member 60 surrounds the outer peripheries of the rear end portions of the wires 30A and 30B, for example. The shield member 60 collectively surrounds the outer peripheries of the rear end portions of the four wires 20A, 20B, 30A, and 30B exposed from the covering members 42, for example. As shown in FIG. 5, the shield member 60 surrounds the outer peripheries of the rear end portions of the four wires 20A, 20B, 30A, and 30B over their entire circumferences, for example. The shield member 60 surrounds the outer periphery of a portion of the shield member 50 surrounding the outer peripheries of the rear end portions of the wires 20 and 30, for example. Accordingly, the outer peripheries of the rear end portions of the wires 20 and 30 are surrounded by both the shield member 50 and the shield member 60.

As shown in FIG. 3, the shield member 60 collectively surrounds the outer peripheries of portions of the plurality of wires 10, i.e., the wires 10A and 10B in their length directions, for example. The shield member 60 surrounds the outer peripheries the front end portions of the wires 10A and 10B over their entire circumferences, for example. As shown in FIGS. 3 and 4, the shield member 60 surrounds the outer periphery of a portion of the shield member 50 surrounding the outer peripheries of the front end portions of the wires 10. Accordingly, the outer peripheries of the front end portions of the wires 10 are surrounded by both the shield member 50 and the shield member 60.

As shown in FIG. 3, the shield member 60 of the present embodiment is formed so as to surround a region in the length direction of the wire harness 1 from the front end portions of the wires 20A and 20B to intermediate portions in the length directions of the wires 10A and 10B. Also, the shield member 60 surrounds the outer periphery of a portion of the shield member 50 in its axial direction. The shield member 60 surrounds the outer periphery of the shield member 50 over its entire circumference, for example. In the region where the outer periphery of the shield member 50 is surrounded by the shield member 60, the wires 10, 20, and 30, the connection portions 40, and the like are surrounded by both the shield member 50 and the shield member 60.

### Grounding Structure of Shield Member 60

As shown in FIGS. 2 and 3, the shield member 60 is grounded to grounding portions of the vehicle V. Both end portions in the axial direction (length direction) of the shield member 60 are grounded, for example. The following describes an example of the grounding structure of the shield member 60.

The rear end portion of the shield member 60 includes a separated portion 61 that does not surround the outer periphery of the wire 10 and the outer periphery of the shield member 50 and extends away from the wire 10. The separated portion 61 extends in a direction that intersects the length direction of the wire 10, for example. The leading end of the separated portion 61 is electrically connected to the earth terminal 70, for example. The leading end of the separated portion 61 and the leading end of the separated portion 51 are collectively connected to the earth terminal 70. The earth terminal 70 in the present embodiment crimps the leading end of the separated portion 51 and the leading end of the separated portion 61 together. The earth terminal 70 electrically connects the leading end of the separated portion 61 and the leading end of the separated portion 51 collectively to the grounding portion G1. The leading end of the separated portion 61 is grounded to the grounding portion G1 via the earth terminal 70. Here, the leading end of the separated portion 61 is the end portion that is the farthest from the wire 10, out of end portions in the axial direction of the separated portion 61. The separated portion 61 and the earth terminal 70 can be joined by being crimped or welded through ultrasonic welding or laser welding, or using any other known joining method.

The front end portion of the shield member 60 includes a separated portion 62 that does not surround the outer periphery of the wire 20 and extends away from the wire 20. The separated portion 62 extends in a direction (downward in the drawing) that intersects the length direction of the wire 20, for example. The leading end of the separated portion 62 is electrically connected to a metal earth terminal 72, for example. The earth terminal 72 is electrically connected to a grounding portion G3 provided in the vehicle body panel or the like, for example. The leading end of the separated portion 62 is grounded to the grounding portion G3 via the earth terminal 72, for example. Here, the leading end of the separated portion 62 is the end portion that is the farthest from the wire 20, out of end portions in the axial direction of the separated portion 62. The separated portion 62 and the earth terminal 72 can be joined by being crimped or welded through ultrasonic welding or laser welding, or using any other known joining method.

With the configuration described above, the shield member 60 exhibits an electromagnetic shielding function of suppressing the radiation of electromagnetic waves from the wires 10, 20, and 30 and the connection portion 40 to the outside of the wire harness 1.

Configuration of Openings 63 and 64

The shield member 60 includes openings 63 and 64 that are provided in intermediate portions in the axial direction of the shield member 60. The openings 63 and 64 are separated away from each other in the axial direction of the shield member 60. The openings 63 and 64 are formed to pass through the shield member 60 in the radial direction of the shield member 60, for example. The openings 63 and 64 are formed by widening meshes in the shield member 60, which is a braided wire, for example. Each of the openings 63 and 64 is formed by widening a single mesh in the shield member 60, for example.

The opening 63 is formed such that the two wires 30A and 30B and the shield member 50 surrounding the outer peripheries of the wires 30A and 30B can pass through the opening 63, for example. The front end portion of the shield member 50 passes through the opening 63 in the state of surrounding the outer peripheries of the front end portions of the wires 30A and 30B, for example. The front end portion of the shield member 50 passing through the opening 63 is drawn to the outside of the shield member 60 in the state of surrounding the outer peripheries of the front end portions of the wires 30A and 30B. Accordingly, the outer peripheries of the front end portions of the wires 30A and 30B drawn to the outside of the shield member 60 are surrounded by only the shield member 50 out of the shield members 50 and 60.

The opening 64 is formed such that the two wires 10A and 10B and the shield member 50 surrounding the outer peripheries of the wires 10A and 10B can pass through the opening 64, for example. The rear end portion of the shield member 50 passes through the opening 64 in the state of surrounding the outer peripheries of the rear end portions of the wires 10A and 10B, for example. The rear end portion of the shield member 50 passing through the opening 64 is drawn to the outside of the shield member 60 in the state of surrounding the outer peripheries of the rear end portions of the wires 10A and 10B. Accordingly, the outer peripheries of the rear end portions of the wires 10A and 10B drawn to the outside of the shield member 60 are surrounded by only the shield member 50 out of the shield members 50 and 60.

In the present embodiment, the wire 10 is an example of a first wire, the wire 20 is an example of a second wire, the wire 30 is an example of a third wire, the rear end portion of the wire 20 is an example of a second-wire-side first end portion, and the front end portion of the wire 20 is an example of a second-wire-side second end portion. Also, the shield member 50 is an example of a first shield member (first shield), the rear end portion of the shield member 50 is an example of a first-shield-side first end portion (first-shield-side first end), and the front end portion of the shield member 50 is an example of a first-shield-side second end portion (first-shield-side second end). Also, the shield member 60 is an example of a second shield member (second shield), and the rear end portion of the shield member 60 is an example of a second-shield-side first end portion (second-shield-side first end).

### Method for Manufacturing Wire Harness 1

Next, the following describes a method for manufacturing the wire harness 1.

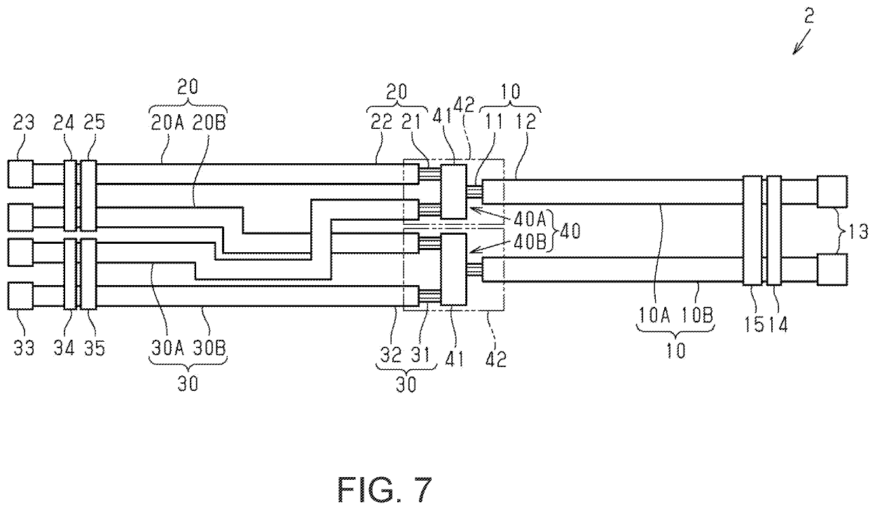

First, in the process shown in FIG. 7, a wire assembly 2 that is not surrounded by the shield members 50 and 60 is prepared. In the wire assembly 2, the terminals 13 are electrically connected to the rear end portions of the wires 10A and 10B, respectively, and the seal member 14 and the retainer 15 are attached to the outer peripheries of the insulating coverings 12 at the rear end portions of the wires 10A and 10B, for example. In the wire assembly 2, the terminals 23 are electrically connected to the front end portions of the wires 20A and 20B, respectively, and the seal member 24 and the retainer 25 are attached to the outer peripheries of the insulating coverings 22 at the front end portions of the wires 20A and 20B, for example. In the wire assembly 2, the terminals 33 are electrically connected to the front end portions of the wires 30A and 30B, respectively, and the seal member 34 and the retainer 35 are attached to the outer peripheries of the insulating coverings 32 at the front end portions of the wires 30A and 30B, for example. In the wire assembly 2, the front end portion of the core wire 11, the rear end portion of the core wire 21, and the rear end portion of the core wire 31 are electrically connected to each other using the crimp terminal 41. In the wire assembly 2, the outer periphery of each crimp terminal 41 is covered by the covering member 42.

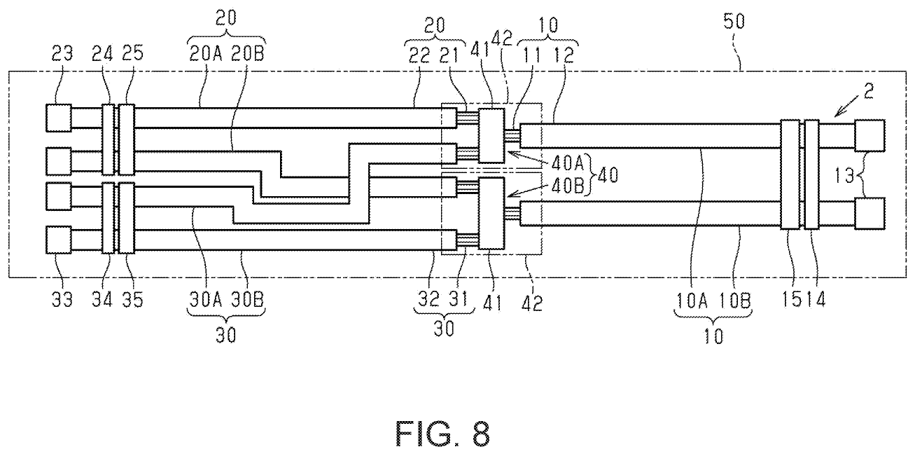

Next, in the process shown in FIG. 8, the entire wire assembly 2 is housed in the tubular shield member 50. That is, the entire wire assembly 2 is surrounded by the tubular shield member 50. The shield member 50 surrounds the outer periphery of the wire assembly 2 over its entire circumference. The shield member 50 surrounds the outer periphery of the wire assembly 2 over the entire length of the wire assembly 2 in its length direction.

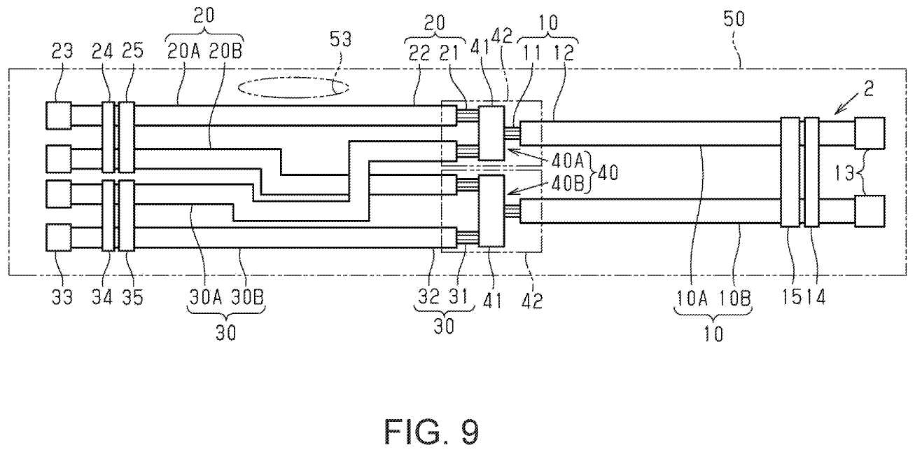

Next, in the process shown in FIG. 9, the opening 53 is formed in an intermediate portion in the axial direction of the shield member 50. The opening 53 is formed by widening a mesh in the shield member 50, which is a braided wire, for example.

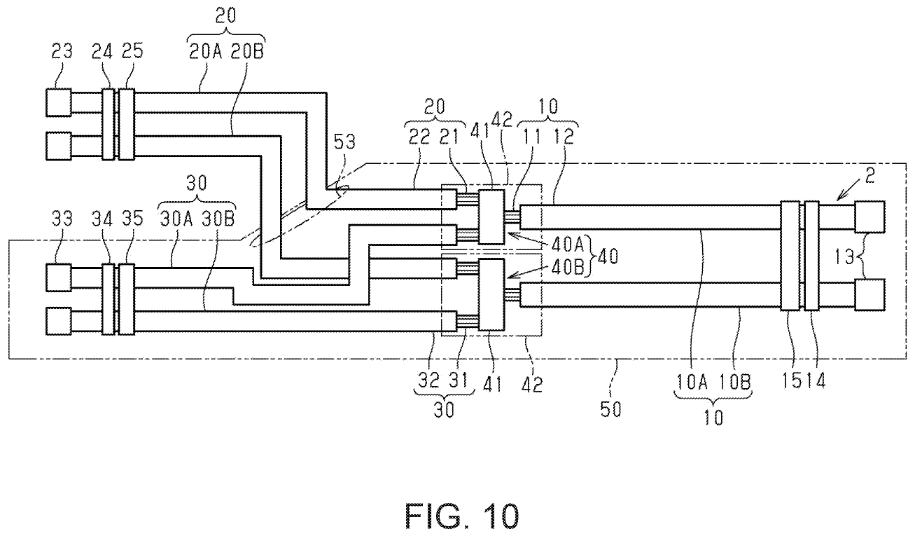

Next, in the process shown in FIG. 10, the front end portions of the wires 20A and 20B are drawn to the outside of the shield member 50 through the opening 53. Thus, a structure (first structure) shown in FIG. 10 is formed. At this time, the two wires 20A and 20B are bundled together using the seal member 24 in the present embodiment. Therefore, the two wires 20A and 20B can be collectively drawn out from the opening 53. This improves ease of work when drawing out the wires 20A and 20B when compared with a case where the two wires 20A and 20B are individually drawn out from the opening 53.

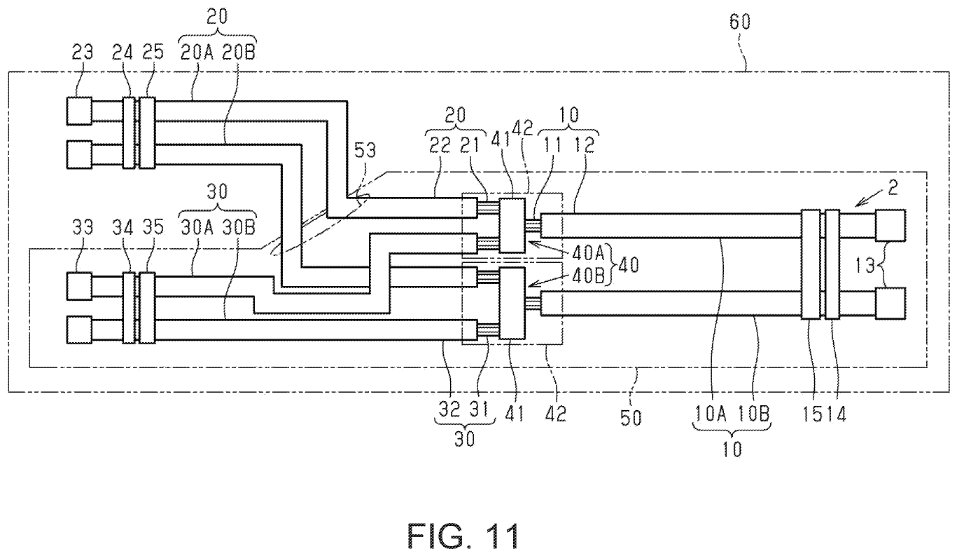

Next, in the process shown in FIG. 11, the entire structure (first structure) shown in FIG. 10 is housed in the tubular shield member 60. That is, the entire structure shown in FIG. 10 is surrounded by the tubular shield member 60. The shield member 60 surrounds the outer periphery of the portion of the shield member 50 surrounding the outer periphery of a portion of the wire assembly 2, and also surrounds the outer periphery of the wire assembly 2 exposed from the shield member 50. The shield member 60 surrounds the outer periphery of the shield member 50 over its entire circumference and the outer periphery of the wire assembly 2 exposed from the shield member 50, i.e., the outer peripheries of the front end portions of the wires 20A and 20B over their entire circumferences. The shield member 60 surrounds the outer peripheries of the terminals 23, the seal member 24, and the retainer 25 over their entire circumferences, for example.

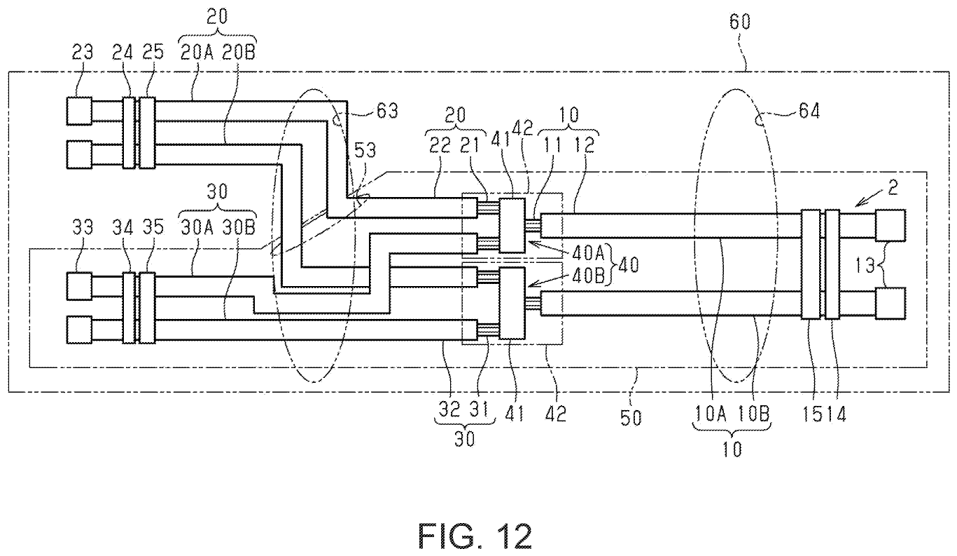

Next, in the process shown in FIG. 12, the openings 63 and 64 are formed in intermediate portions in the axial direction of the shield member 60. The openings 63 and 64 are separated away from each other in the axial direction of the shield member 60. The openings 63 and 64 are formed by widening meshes in the shield member 60, which is a braided wire, for example.

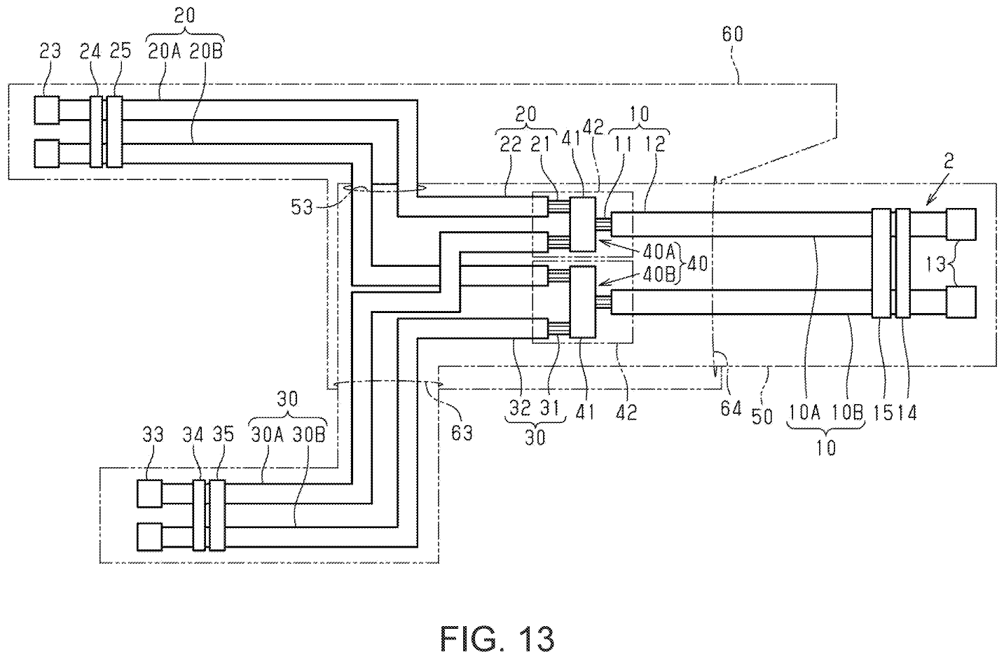

Next, in the process shown in FIG. 13, the front end portions of the wires 30A and 30B and the shield member 50 surrounding the outer peripheries of the wires 30A and 30B are drawn to the outside of the shield member 60 through the opening 63. Accordingly, the shield member 50 passes through the opening 63 in the state of surrounding the outer peripheries of the wires 30A and 30B. Also, in the process shown in FIG. 13, the rear end portions of the wires 10A and 10B and the shield member 50 surrounding the outer peripheries of the wires 10A and 10B are drawn to the outside of the shield member 60 through the opening 64. Accordingly, the shield member 50 passes through the opening 64 in the state of surrounding the outer peripheries of the wires 10A and 10B. In this process, the two wires 10A and 10B are bundled together using the seal member 14, and the two wires 30A and 30B are bundled together using the seal member 34. Therefore, the two wires 10A and 10B can be collectively drawn out from the opening 64, and the two wires 30A and 30B can be collectively drawn out from the opening 63. This improves ease of work when drawing out the wires 10A, 10B, 30A, and 30B when compared with the case where the wires 10A and 10B are not bundled together and the wires 30A and 30B are not bundled together.

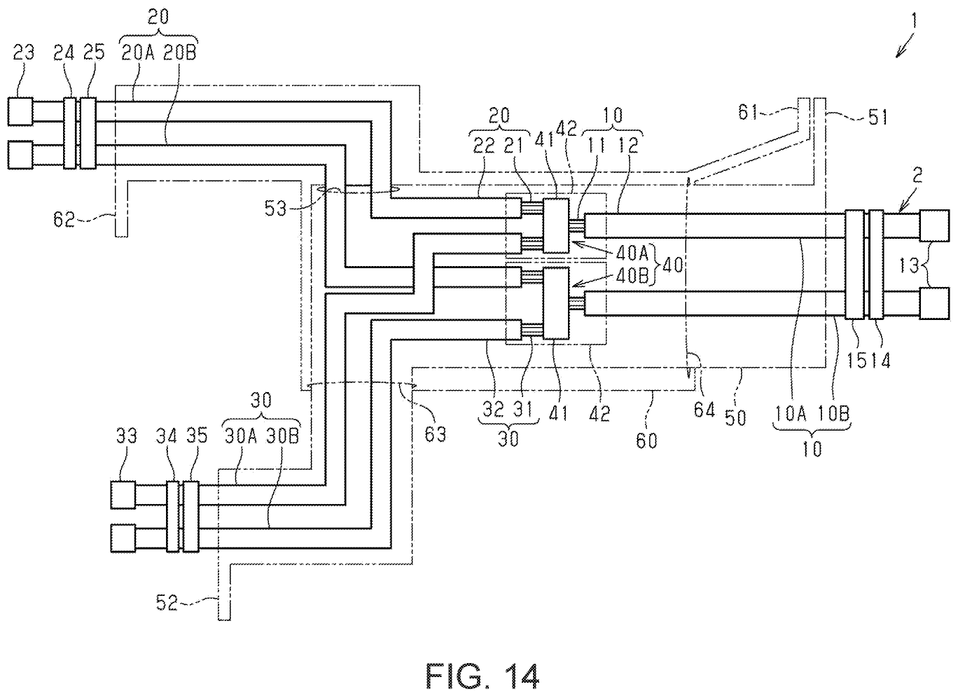

Next, in the process shown in FIG. 14, the separated portion 51 is formed in the rear end portion of the shield member 50, and the separated portion 52 is formed in the front end portion of the shield member 50. Also, the separated portion 61 is formed in the rear end portion of the shield member 60, and the separated portion 62 is formed in the front end portion of the shield member 60.

Thereafter, as shown in FIG. 3, the earth terminal 70 is connected to the leading ends of the separated portions 51 and 61, the earth terminal 71 is connected to the leading end of the separated portion 52, and the earth terminal 72 is connected to the leading end of the separated portion 62. Also, the connector C1 is connected to the rear end portion of the wire 10, the connector C2 is connected to the front end portion of the wire 20, and the connector C3 is connected to the front end portion of the wire 30. Through the manufacturing processes described above, the wire harness 1 of the present embodiment can be manufactured.

Next, the following describes the operations and effects of the present embodiment.

(1) The tubular shield member 50 surrounding the outer periphery of the connection portion 40 in which the wires 10, 20, and 30 are electrically connected to each other is provided. Also, the tubular shield member 60 surrounding the outer periphery of the portion of the shield member 50 surrounding the outer periphery of the connection portion 40 is provided. With this configuration, the outer periphery of the connection portion 40 is surrounded by the shield member 50, and the outer periphery of the shield member 50 is surrounded by the shield member 60. Accordingly, the outer periphery of the connection portion 40 is surrounded by both the shield member 50 and the shield member 60. Therefore, even when one of the shield members 50 and 60 is damaged, for example, the other of the shield members 50 and 60 can serve as an electromagnetic shield for the connection portion 40. Therefore, it is possible to favorably suppress a reduction in the electromagnetic shielding performance in the connection portion 40.

For example, the outer shape of the connection portion 40 may be larger than outer shapes of the other portions because the core wire 11 of the wire 10, the core wire 21 of the wire 20, and the core wire 31 of the wire 30 are connected using the crimp terminal 41 in the connection portion 40. In this case, the connection portion 40 is likely to come into contact with the shield member 50, and it is conceivable that the shield member 50 will be damaged due to the contact, for example, metal strands constituting the braided wire may be cut. Also, when the connection portion 40 includes a sharp edge, it is conceivable that the shield member 50 will be damaged by coming into contact with the edge. In the wire harness 1 of the present embodiment, the shield member 60 can serve as an electromagnetic shield for the connection portion 40 even when the shield member 50 is damaged as described above. Therefore, it is possible to favorably suppress a reduction in the electromagnetic shielding performance in the connection portion 40.

(2) The outer periphery of the rear end portion of the wire 20 is surrounded by the shield member 50, and the outer periphery of the portion of the shield member 50 surrounding the outer periphery of the rear end portion of the wire 20 is surrounded by the shield member 60. With this configuration, the outer periphery of the rear end portion of the wire 20 is surrounded by both the shield member 50 and the shield member 60. Therefore, even when one of the shield members 50 and 60 is damaged, for example, the other of the shield members 50 and 60 can serve as an electromagnetic shield for the rear end portion of the wire 20. Therefore, it is possible to favorably suppress a reduction in the electromagnetic shielding performance in the rear end portion of the wire 20.

(3) The outer periphery of the wire 20 exposed from the shield member 50 is surrounded by the shield member 60. With this configuration, the outer periphery of the portion of the wire 20 drawn to the outside of the shield member 50 is surrounded by the shield member 60, which serves as an electromagnetic shield for the portion. Therefore, it is possible to favorably suppress a reduction in the electromagnetic shielding performance in the portion exposed from the shield member 50.

(4) The outer periphery of the wire 30 is surrounded by the shield member 50, and the outer periphery of a portion of the shield member 50 surrounding the outer periphery of the rear end portion of the wire 30 is surrounded by the shield member 60. With this configuration, the outer periphery of the rear end portion of the wire 30 is surrounded by both the shield member 50 and the shield member 60. Therefore, even when one of the shield members 50 and 60 is damaged, for example, the other of the shield members 50 and 60 can serve as an electromagnetic shield for the rear end portion of the wire 30. Therefore, it is possible to favorably suppress a reduction in the electromagnetic shielding performance in the rear end portion of the wire 30.

(5) The front end portion of the shield member 50 is drawn to the outside of the shield member 60 from the opening 63 in the state of surrounding the outer periphery of the wire 30. Accordingly, the outer periphery of the portion of the wire 30 drawn to the outside of the shield member 60 is surrounded by the shield member 50, which serves as an electromagnetic shield for the portion. Therefore, it is possible to favorably suppress a reduction in the electromagnetic shielding performance in the portion exposed from the shield member 60.

(6) The rear end portion of the shield member 50 is drawn to the outside of the shield member 60 from the opening 64 in the state of surrounding the outer periphery of the wire 10. Accordingly, the outer periphery of the portion of the wire 10 drawn to the outside of the shield member 60 is surrounded by the shield member 50, which serves as an electromagnetic shield for the portion. Therefore, it is possible to favorably suppress a reduction in the electromagnetic shielding performance in the portion exposed from the shield member 60.

(7) The leading end of the separated portion 51 of the shield member 50 and the leading end of the separated portion 61 of the shield member 60 are collectively electrically connected to the grounding portion G1. Accordingly, the number of grounding sites can be reduced when compared with a case where the leading end of the separated portion 51 and the leading end of the separated portion 61 are electrically connected to different grounding portions. Therefore, it is possible to reduce the number of fastening points at which grounding members such as the earth terminal 70 are fastened to grounding portions such as the grounding portion G1.

(8) The connector C1 is electrically connectable to the external connector 101 that is connected to the external power source 100. In this case, a large current flows through the wire 10, which is electrically connected to the connector C1, and accordingly, electromagnetic noise is likely to be generated in the wire 10 and the connection portion 40. However, in the wire harness 1 of the present embodiment, the outer periphery of the connection portion 40 is surrounded by both the shield member 50 and the shield member 60 to suppress a reduction in the electromagnetic shielding performance in the connection portion 40. Therefore, even in the case where electromagnetic noise is likely to be generated, it is possible to favorably suppress the radiation of electromagnetic noise generated from the connection portion 40 to the outside of the wire harness 1.

### Other Embodiments

The above embodiment can be implemented with the following changes. The above embodiment and the following variations can be implemented in combination so long as no technical contradiction is incurred.

In the above embodiment, the leading end of the separated portion 51 of the shield member 50 and the leading end of the separated portion 61 of the shield member 60 are electrically connected to the single earth terminal 70 (grounding member/ground). However, there is no limitation to this configuration.

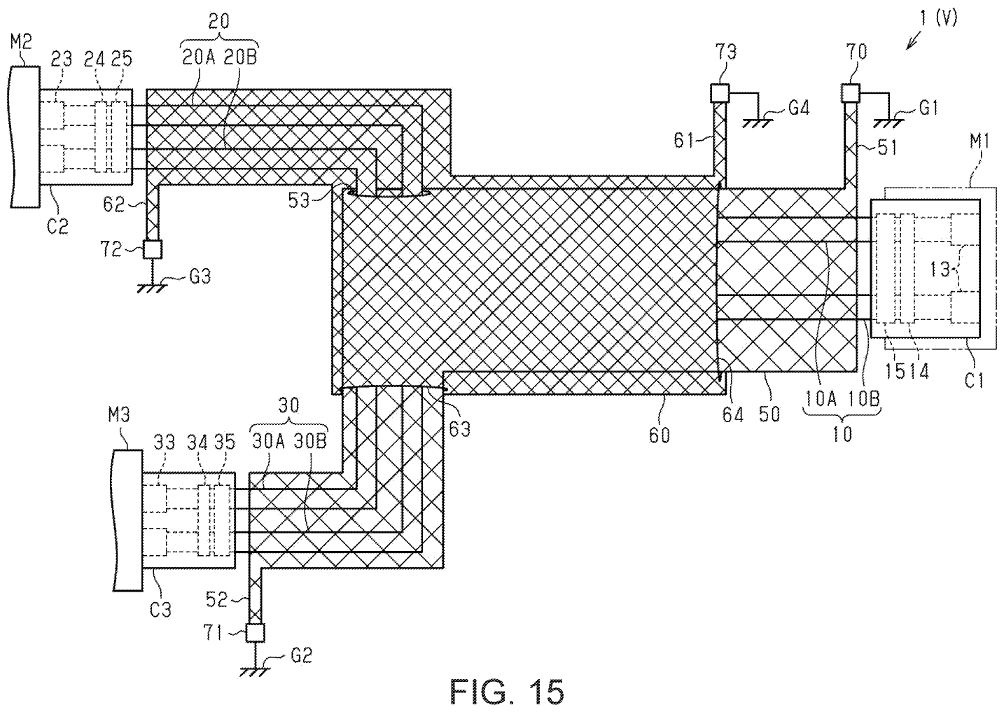

For example, as shown in FIG. 15, a configuration is also possible in which the leading end of the separated portion 51 of the shield member 50 is electrically connected to the earth terminal 70 and the leading end of the separated portion 61 of the shield member 60 is electrically connected to an earth terminal 73 other than the earth terminal 70. The earth terminal 70 is electrically connected to the grounding portion G1, for example. The leading end of the separated portion 51 is grounded to the grounding portion G1 via the earth terminal 70. The earth terminal 73 is electrically connected to a grounding portion G4 provided in the vehicle body panel or the like, for example. The leading end of the separated portion 61 is grounded to the grounding portion G4 via the earth terminal 73.

In the above embodiment, the separated portion 51 is provided in the rear end portion of the shield member 50 and the earth terminal 70 is electrically connected to the leading end of the separated portion 51. However, the grounding structure for grounding the rear end portion of the shield member 50 to the grounding portion G1 is not limited to this structure.

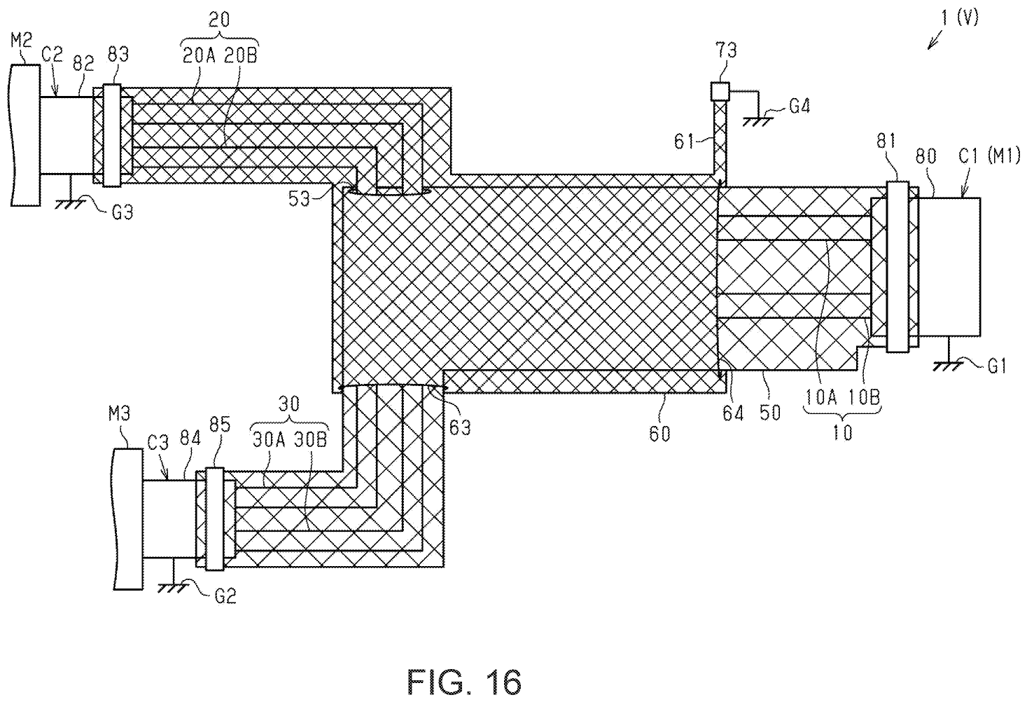

For example, as shown in FIG. 16, it is possible to provide a metal tubular member 80 on the connector C1 and electrically connect the rear end portion of the shield member 50 to the outer circumferential surface of the tubular member 80. The rear end portion of the wire 10 is housed in the tubular member 80. The rear end portion of the shield member 50 surrounds the outer periphery of the tubular member 80. The rear end portion of the shield member 50 surrounds the outer periphery of the tubular member 80 over its entire circumference, for example. The wire harness 1 of this variation includes a fixing member 81 for fixing the shield member 50 to the tubular member 80. The fixing member 81 fixes the shield member 50 to the outer circumferential surface of the tubular member 80 in a state where the rear end portion of the shield member 50 is in contact with the tubular member 80, for example. As a result of the fixing member 81 being tightened radially inward of the tubular member 80, the rear end portion of the shield member 50 is fixed in the state of being in direct contact with the outer circumferential surface of the tubular member 80. Thus, the shield member 50 is electrically and mechanically connected to the tubular member 80. The shield member 50 of this variation is grounded to the grounding portion G1 via the tubular member 80. For example, a caulking ring, a cable tie, or a tape member can be used as the fixing member 81. Metal materials such as iron-based materials, aluminum-based materials, and copper-based materials can be used as the material of the caulking ring, for example.

In this configuration, the rear end portion of the shield member 50 surrounds the outer periphery of the tubular member 80 provided on the connector C1, and accordingly, the rear end portion of the wire 10 can be kept from being exposed from the shield member 50. Therefore, it is possible to favorably suppress a reduction in the electromagnetic shielding performance in the wire harness 1.

For example, as shown in FIG. 16, it is also possible to provide a metal tubular member 82 on the connector C2 and electrically connect the front end portion of the shield member 60 to the outer circumferential surface of the tubular member 82. The front end portion of the shield member 60 surrounds the outer periphery of the tubular member 82. The front end portion of the shield member 60 is fixed to the outer circumferential surface of the tubular member 82 using a fixing member 83 that is similar to the fixing member 81. The shield member 60 of this variation is grounded to the grounding portion G3 via the tubular member 82.

For example, as shown in FIG. 16, it is also possible to provide a metal tubular member 84 on the connector C3 and electrically connect the rear end portion of the shield member 50 to the outer circumferential surface of the tubular member 84. The front end portion of the shield member 50 surrounds the outer periphery of the tubular member 84. The front end portion of the shield member 50 is fixed to the outer circumferential surface of the tubular member 84 using a fixing member 85 that is similar to the fixing member 81. The shield member 50 of this variation is grounded to the grounding portion G2 via the tubular member 84.

In the above embodiment, the shield member 60 may surround the outer periphery of the wire 10 over the entire length of the wire 10 in its length direction.

In the above embodiment, after the terminal 23, the seal member 24, and the retainer 25 are attached to the front end portion of the wire 20, the front end portion of the wire 20 is drawn out from the opening 53, but there is no limitation to this procedure. For example, the terminal 23, the seal member 24, and the retainer 25 may be attached to the front end portion of the wire 20 after the wires 10, 20, and 30 are surrounded by the shield members 50 and 60.

In the wire harness 1 of the above embodiment, the two branch wires 20 and 30 branch from the trunk wire 10, but there is no limitation to this configuration. For example, three or more branch wires may branch from the trunk wire 10.

In the above embodiment, the wire 10 is embodied as an unshielded wire, but there is no limitation to this configuration. For example, the wire 10 may also be embodied as a shielded wire that has its own electromagnetic shielding structure. In this case, the rear end portion of the wire 10 may be exposed from the shield members 50 and 60, for example.

In the above embodiment, the wire 20 is embodied as an unshielded wire, but the wire 20 may also be embodied as a shielded wire. In this case, the front end portion of the wire 20 may be exposed from the shield members 50 and 60, for example.

In the above embodiment, the wire 30 is embodied as an unshielded wire, but the wire 30 may also be embodied as a shielded wire. In this case, the front end portion of the wire 30 may be exposed from the shield members 50 and 60, for example.

In the wire harness 1 of the above embodiment, an outer covering member that surrounds the outer peripheries of the wires 10, 20, and 30 may also be provided. As the outer covering member, it is possible to use a metal pipe, a resin pipe, a corrugated tube, a waterproof cover made of rubber, or a combination of any of these, for example.

In the above embodiment, the wire 10 is constituted by the two wires 10A and 10B, the wire 20 is constituted by the two wires 20A and 20B, and the wire 30 is constituted by the two wires 30A and 30B, but there is no limitation to this configuration. The number of wires constituting the wires 10, 20, and 30 can be changed according to the specifications of the vehicle V. For example, the wires 10, 20, and 30 may be constituted by three or more wires.

In the above embodiment, both of the in-vehicle devices M2 and M3 are embodied as batteries, but there is no limitation to this configuration. For example, a configuration is also possible in which one of the in-vehicle devices M2 and M3 is embodied as a battery and the other of the in-vehicle devices M2 and M3 is embodied as a power supply device that supplies power to the charging inlet M1. For example, a DC-DC converter can be used as the power supply device.

In the above embodiment, the in-vehicle devices M2 and M3 are embodied as batteries, but there is no limitation to this configuration. There is no particular limitation on the in-vehicle devices M2 and M3 so long as the in-vehicle devices M2 and M3 are electrical devices installed in the vehicle V.

In the above embodiment, the connector C1 is embodied as a connector (charging connector) that constitutes the charging inlet M1, but there is no limitation to this configuration. For example, the connector C1 may be embodied as a connector that is provided in an in-vehicle device other than the charging inlet Ml. Also, the connector C1 may be embodied as a connector that is electrically connected to an in-vehicle device other than the charging inlet M1.

The arrangement relationship between the charging inlet M1 and the in-vehicle devices M2 and M3 in the vehicle V is not limited to that in the above embodiment, and may be changed as appropriate according to the configuration of the vehicle V.

The disclosed embodiment is an illustrative example in all aspects and should not be considered as restrictive. The scope of the present invention is defined not by the above descriptions but by the claims, and is intended to encompass all modifications within the meanings and scope that are equivalent to the claims.

What is claimed is:

1. A wire harness comprising:
a first wire that is electrically connectable to a first connector installed in a vehicle;
a second wire that is electrically connected to the first wire;
a third wire that is electrically connected to the first wire;
a connection where the first wire, the second wire, and the third wire are electrically connected to each other;
a tubular first shield that surrounds an outer periphery of the connection and an outer periphery of the first wire; and
a tubular second shield that surrounds an outer periphery of a portion of the first shield and an outer periphery of the second wire, the portion of the first shield surrounding the outer periphery of the connection.

2. The wire harness according to claim 1, wherein:
the first shield surrounds the outer periphery of a portion of the second wire,
the first shield includes a first opening that is provided in an intermediate portion in an axial direction of the first shield,
the second wire includes a second-wire-side first end that is connected to the connection and a second-wire-side second end that is opposite to the second-wire-side first end,
the second-wire-side second end of the second wire is drawn to an outside of the first shield from the first opening, and
the second shield surrounds the outer periphery of the portion of the first shield and the outer periphery of the second wire exposed from the first shield, the portion of the first shield surrounding the outer periphery of the second wire.

3. The wire harness according to claim 2, wherein:
the first shield surrounds an outer periphery of the third wire,
the first shield includes a first-shield-side first end that surrounds the outer periphery of the first wire and a first-shield-side second end that is opposite to the first-shield-side first end in the axial direction of the first shield,
the second shield surrounds the outer periphery of a portion of the first shield in a portion in which the first shield surrounds the outer periphery of the third wire,
the second shield includes a second opening that is provided in an intermediate portion in an axial direction of the second shield, and
the first-shield-side second end of the first shield is drawn to an outside of the second shield from the second opening in the state of surrounding the outer periphery of the third wire.

4. The wire harness according to claim 3, wherein:
the second shield surrounds the outer periphery of a portion of the first shield in a portion in which the first shield surrounds the outer periphery of the first wire,
the second shield includes a third opening that is provided in an intermediate portion in the axial direction of the second shield, and
the first-shield-side first end of the first shield is drawn to the outside of the second shield from the third opening in the state of surrounding the outer periphery of the first wire.

5. The wire harness according to claim 3, wherein:
the first wire is an unshielded wire that does not have its own electromagnetic shielding structure,
the second wire is an unshielded wire that does not have its own electromagnetic shielding structure, and
the third wire is an unshielded wire that does not have its own electromagnetic shielding structure.

6. The wire harness according to claim 3, wherein:
the first-shield-side first end of the first shield includes a first separated portion that does not surround the outer periphery of the first wire and extends away from the first wire, and
the wire harness further includes a ground that is electrically connected to a leading end of the first separated portion and is electrically connected to a grounding portion provided in the vehicle.

7. The wire harness according to claim 6, wherein:
a second-shield-side first end in the axial direction of the second shield includes a second separated portion that does not surround the outer periphery of the first wire and extends away from the first wire,
a leading end of the second separated portion is electrically connected to the ground, and
the ground electrically connects the leading end of the first separated portion and the leading end of the second separated portion collectively to the grounding portion.

8. The wire harness according to claim 1, wherein the first connector is electrically connectable to an external connector that is connected to an external power source.

9. A method for manufacturing a wire harness, comprising:
forming a wire assembly that includes a first wire, a second wire, a third wire, and a connection where the first wire, the second wire, and the third wire are electrically connected to each other;
housing the wire assembly in its entirety in a tubular first shield;
forming a first opening in an intermediate portion in an axial direction of the first shield;
forming a first structure by drawing a second-wire-side second end of the second wire to an outside of the first shield from the first opening, the second-wire-side second end being opposite to a second-wire-side first end of the second wire that is connected to the connection;
housing the first structure in its entirety in a tubular second shield;
forming a second opening in an intermediate portion in an axial direction of the second shield; and
drawing a portion of the first shield to an outside of the second shield from the second opening, the portion of the first shield surrounding an outer periphery of the third wire in the first structure,
wherein an outer periphery of the connection is surrounded by the first shield, and an outer periphery of a portion of the first shield is surrounded by the second shield, the portion of the first shield surrounding the outer periphery of the connection.

10. The method for manufacturing a wire harness according to claim 9, wherein:
the first wire includes a plurality of first wires, the second wire includes a plurality of second wires, the third wire includes a plurality of third wires, and the connection includes a plurality of connections, and
in the forming of the wire assembly, a common seal is attached to the second-wire-side second ends of the plurality of second wires.
